(19) United States
(12) Patent Application Publication
(10) Pub. No.: US 2023/0343483 A1
(43) Pub. Date: Oct. 26, 2023

(54) MULTI-CORE CABLE FOR CONNECTING AN ELECTRICAL DEVICE, IN PARTICULAR IN A MOTOR VEHICLE, FOR EXAMPLE FOR CONNECTING A HEADLIGHT

(71) Applicant: Hella GmbH & Co. KGaA, Lippstadt (DE)

(72) Inventor: Michael Naber, Ahlen (DE)

(21) Appl. No.: 18/302,927

(22) Filed: Apr. 19, 2023

(30) Foreign Application Priority Data
Apr. 25, 2022 (DE) 102022109844.3

(51) Int. Cl. H01B 7/00

(52) U.S. Cl. CPC H01B 7/0009

(57) ABSTRACT

A multi-core cable is provided for connecting an electric device, in particular in a motor vehicle, for example for connecting a headlamp or control units in the headlamp. The cable features one or several first cores for the ground connection of the device and one or several further cores. The at least one further core does not run spirally and the at least one first core to the ground connection is wound spirally around the further cores. The cable does not feature any metal foil as shielding.

### CROSS REFERENCE

This application claims priority to German Application No. 10 2022 109844.3, filed Apr. 25, 2022, the entirety of which is hereby incorporated by reference.\

### FIELD OF THE INVENTION

The invention relates to a multi-core cable for connecting an electric device, in particular in a motor vehicle, for example for connecting a headlamp or control units in the headlamp, where the cable features one or several first cores for the ground connection of the device and one or several further cores.

### BACKGROUND OF THE INVENTION

It is known that disruptions or failure of electric devices, in particular also in motor vehicles, are caused by electromagnetic waves being incoupled into the cables. This can be prevented by shielded cables.

Shielded cables are known from the state of the art in which the cores of the cable are wrapped in a metal-foil tape. Known shielded cables include coaxial cables and twisted-pair cables that are used for the transmission of high-frequency signals. One example of a cable with shielding made of a metal-foil tape is known from the document DE 196 20 024 A1.

Shielded cables require a ground connection for the shielding at one or both ends. This can be problematic with electric devices that do not provide a ground connection for contacting the shielding.

As an alternative or in addition to the use of shielded cables, it is possible to use ferrite cores to increase resistance to interference. A ferrite core requires installation space and must be fixed in a way to protect it against vibration load. This is frequently not possible in particular in motor vehicles for design reasons.

Document DE 196 20 024 A1 does already disclose the use of ground cores or earth conductors to improve resistance to interference. These earth conductors are, however, only used in conjunction with and as an addition to shielding foils. As the earth conductors simultaneously contact both a radially inner first shielding foil and a radially outer second shielding foil, a continuous, electric ground connection is provided over the length of the cable. This makes it possible to ensure the electromagnetic shielding effect of the two shielding foils even in the event of one or both of the shielding foils breaking off, as the earth conductors bridge over such a longitudinal break and reestablish the electrical contact to two or more part lengths possibly broken apart of the first shielding foil and/or the second shielding foil. As long as, in particular, at least one of the several earth conductors remains intact, any longitudinal breaks occurring in the electromagnetic shielding foils can be remedied by bridging over by means of the earth conductors. The earth conductors preferentially make contact to the ground potential or the earth potential and therefore also the shielding foils to which they make contact. FIG. 2 of document DE 196 20 024 A1 shows a cross-section of the cable. FIG. 4 of this document DE 196 20 024 A1 shows a variant with only one shielding foil. FIGS. 5 and 6 of document DE 196 20 024 A1 show a schematic view of a variant with only one shielding foil. A complete representation of the cross-sections of this last variant is missing, however, which means that the exact design of the variant in accordance with FIGS. 5 and 6 remains open. Document DE 196 20 024 A1 does not teach that a shielding foil can be dispensed with due to the earth conductor. On the contrary, document DE 196 20 024 A1 teaches that the breaks in the shielding can be remedied by means of the earth conductors and the shielding foils can be connected to the ground or earth potential.

### BRIEF SUMMARY OF THE INVENTION

The task underlying the invention is to improve the resistance to interference of electric cables and/or electric devices connected to such electric cables without shielded cables or ferrite cores being required for this purpose.

In accordance with the invention, this task is solved by the at least one further core not running spirally and the at least one first core to the ground connection is wound spirally around the further core and the cable does not feature any metal foil as shielding.

Instead of shielding made of a metal foil tape, the invention specifies that a ground core of the inventive cable be used in order to prevent the incoupling of interference into the cable and to achieve the desired level of resistance to interference.

The invention teaches that the shielding foil can be dispensed with and instead a conductor be used for the ground connection of the electric device, which conductor is necessary anyway in the cable for the electrical connection of the device in order to improve resistance to interference and to avoid the incoupling of electromagnetic interference. With the invention, the spiraled ground conductors are there not to remedy breaks in shielding but to ensure resistance to interference themselves.

According to the invention, the inventive cable can feature several further cores that do not run spirally. The at least one first core for ground connection can be wound spirally around all further cores.

An inventive cable can feature several first cores for ground connection and all these first cores can be wound spirally around the single further core or around all further cores. If there are several first cores, the several first cores for ground connection can be wound in opposite directions. Preferentially, one half of the cables are wound in one winding direction and the other half are wound in a second winding direction opposite to the first.

If an inventive cable has several first cores for ground connection, they can be insulated from each other. This does not exclude the first cores being indirectly connected to each other, for example, in the device connected via the cable or in the devices connected to each other via the cable and for that reason are on the same potential.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 is a side view of the sample embodiment.

FIG. 2 is a cross-section through the sample embodiment.

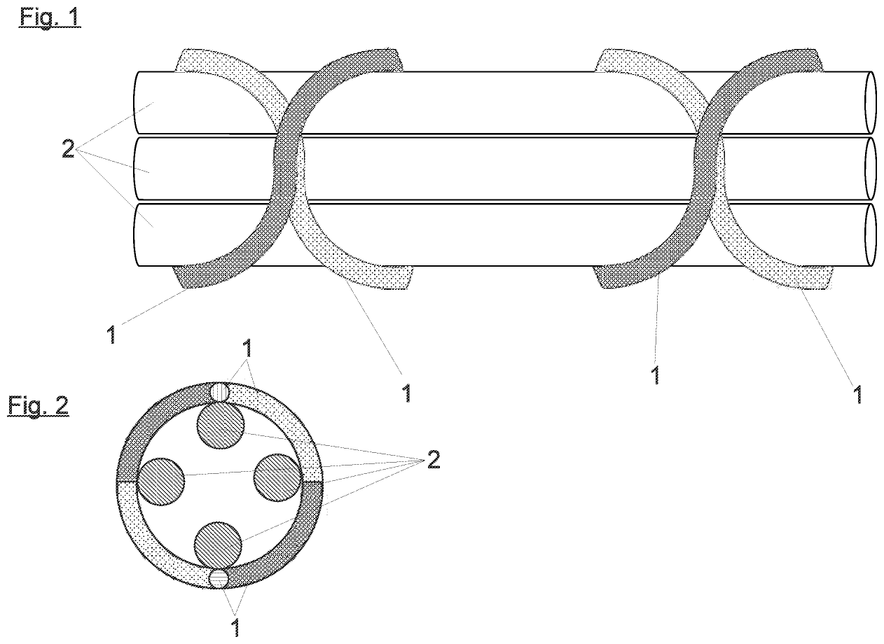

### DETAILED DESCRIPTION OF THE DRAWINGS

The sample embodiment for an inventive cable L has two first cores 1 and four further cores 2. The further cores 2 run to a large extent parallel to each other. The first two cores are wound spirally around the further cores. In this context, the windings of the two first cores 1 run in opposite directions. The one first core is spiraled to the right and the other first core 1 is spiraled to the left. In this context, the pitch of the spirals is identical. This means they have the same pitch length.

### LIST OF REFERENCE NUMBERS

1 First cores
2 Further cores
L Cable

1. A multi-core cable (L) for connecting an electric device, the cable (L) comprising:
At least one first core for ground connection of the electrical device, and at least one further core,
wherein the at least one further core does not run spirally, and the at least one first core for ground connection is wound spirally around the at least one further core, and the cable (L) does not feature any metal foil as shielding.

2. The cable in accordance with claim 1, wherein the cable (L) features at least two further cores that do not run spirally, and wherein the at least one first core for ground connection is would spirally around the at least two further cores for ground connection.

3. The cable in accordance with claim 1, the cable including at least two first cores for ground connection, wherein all of the at least two first cores are wound spirally around the at least one further core.

4. The cable in accordance with claim 3, wherein the at least two of the at least two first cores for ground connection are wound in directions opposite to each other.

5. The cable in accordance with claim 4, wherein the at least two first cores for ground connection are insulated from each other.
